(19) United States
(12) Patent Application Publication
(10) Pub. No.: US 2022/0378019 A1
(43) Pub. Date: Dec. 1, 2022

(54) LEASH FOR FACILITATING DETANGLING

(71) Applicant: Noah Elgart, Rockaway Park, NY (US)

(72) Inventor: Noah Elgart, Rockaway Park, NY (US)

(21) Appl. No.: 17/887,189

(22) Filed: Aug. 12, 2022

Related U.S. Application Data
(62) Division of application No. 17/142,727, filed on Jan. 6, 2021.

(51) Int. Cl. A01K 27/00

(52) U.S. Cl. CPC A01K 27/005; A01K 27/003

(57) ABSTRACT

A pet leash for facilitating detangling has a rope with a length disposed between a first end and a second end opposite the first end. A first loop is attached at the first end of the rope, and a second loop is attached at the second end of the rope. Each loop is meant to be held by a hand of a person. A first base is located where the first loop is attached to the first end of the rope, and a second base is located where the second loop is attached to the second end of the rope. A ring is attached to the rope. The ring slides along the length of the rope between the first base and the second base, so as to prevent tangling of the rope during use. A clip is attached to the ring. The clip allows for attachment to and detachment from the collar of the pet.

### CROSS-REFERENCE TO RELATED APPLICATIONS

This patent application is a divisional application of, and claims priority to, patent application Ser. No. 17/142,727 filed Jan. 6, 2021. The subject matter of patent application Ser. No. 17/142,727 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to leashes for pets and, more specifically, to a leash designed to prevent and reduce tangling during use, in addition to facilitating detangling.

### BACKGROUND

A leash is an assembly used for walking pets, particularly dogs. A leash typically includes a rope or cord that has a handle at one end and a clip at an opposing end. The handle is to be held by a person while walking the pet, and the clip is to be attached to a collar of the pet.

A well-known problem associated with leashes involves tangling of the rope or cord during use. While a person is walking a pet, the pet may not always walk in a straight manner, thus causing the rope or cord to become tangled on objects such as poles, or with other pets that are on leashes. This can result in the person losing control of the leash, which can create a risk of the pet running loose and becoming lost, or worse, running into a dangerous situation, such as vehicular traffic. Furthermore, the pet may tangle the rope or cord around itself, which may result in strangling, asphyxiation, and even death.

To untangle the rope or cord, the person usually must stop walking, let go of the handle, and manually remove any knots or kinks in the rope or cord. This is not only disruptive to taking a walk, but also, as stated above, may result in the pet becoming loose or injured.

Therefore, a need exists for improvements over the prior art, and, more particularly, for a leash that attaches to and detaches from a collar for a pet, while also preventing and/or reducing tangling of a rope while a person is walking the pet and/or facilitating detangling of the leash.

### SUMMARY

A pet leash for facilitating detangling is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a pet leash for facilitating detangling is disclosed. The leash has a rope with a length disposed between a first end and a second end opposite the first end. A first loop is attached at the first end of the rope, and a second loop is attached at the second end of the rope. Each loop is meant to be held by a hand of a person. A first base is located where the first loop is attached to the first end of the rope, and a second base is located where the second loop is attached to the second end of the rope. A ring is attached to the rope. The ring slides along the length of the rope between the first base and the second base, so as to prevent tangling of the rope during use. A clip is attached to the ring. The clip allows for attachment to and detachment from the collar of the pet.

Also disclosed is a method of using and detangling a pet leash configured for attachment to and detachment from a collar of a pet, comprising the steps of: holding a first loop at a first end of a rope of the leash, opposite a second loop at a second end of the rope, wherein a first base is located at the first end and a second base is located at the second end, wherein a ring is attached to, and slides along, a length of the rope between the first base and the second base, and wherein a clip is attached to the ring for attachment to and detachment from the collar of the pet; enabling the ring to slide to the second base; letting go of the first loop when the rope becomes tangled; holding the second loop; pulling the rope via the second loop; and enabling the ring to slide along the length of the rope to the first base, thereby detangling the rope.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a front perspective view of a pet leash for facilitating detangling, the pet leash shown in an extended orientation, according to an example embodiment.

FIG. 2 is another front perspective view of a pet leash for facilitating detangling, the pet leash shown in an extended orientation with a pet and its owner, according to an example embodiment.

FIG. 3 is another front perspective view of a pet leash for facilitating detangling, the pet leash shown in an extended orientation with a collar, according to an example embodiment that includes knots.

FIG. 4 is another front perspective view of a pet leash for facilitating detangling, the pet leash shown in an extended orientation, according to an example embodiment that includes holding rings.

FIG. 5 is a top perspective view of a pet leash for facilitating detangling, wherein the owner is using both loops and both hands, according to an example embodiment.

FIG. 6 is a front perspective view of a pet leash for facilitating detangling, the pet leash shown in an extended orientation, with the pet on a distal end, according to an example embodiment.

FIG. 7A is another front perspective view of a pet leash for facilitating detangling, the pet leash shown in a tangled orientation with the pet on a proximal end, according to an example embodiment.

FIG. 7B is another front perspective view of a pet leash for facilitating detangling, the pet leash shown in a tangled orientation with the pet moving across the leash, according to an example embodiment.

FIG. 8 is another front perspective view of a pet leash for facilitating detangling, the pet leash shown in an extended orientation with the pet located on a distal end, according to an example embodiment.

FIG. 9A is another front perspective view of a pet leash for facilitating detangling, the pet leash shown in a tangled orientation with the pet located at a proximal end. according to an example embodiment.

FIG. 9B is another front perspective view of a pet leash for facilitating detangling, the pet leash shown in a tangled orientation with the pet moving across the leash, according to an example embodiment.

FIG. 10 is another front perspective view of a pet leash for facilitating detangling, the pet leash shown in an extended orientation with the pet moved across the leash, according to an example embodiment.

FIG. 11 is a flow chart of a method for using and detangling a pet leash for facilitating detangling, according to an example embodiment.

FIG. 12 is a flow chart of further steps of the method of FIG. 11, according to an example embodiment.

### DETAILED DESCRIPTION

The following detailed description refers to the accompanying drawings. Wherever possible, the same reference numbers are used in the drawings and the following description to refer to the same or similar elements. While embodiments herein may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed embodiments improve upon the prior art by providing a leash that attaches to and detaches from a collar of a pet, while preventing and reducing tangling while walking a pet. Current leash designs are prone to tangling, which may result in loss, injury, or even death of a pet. The claimed embodiments deal with this problem by utilizing a leash with two loops on opposing ends of each other on a rope, which are meant to be held by a person while walking the pet. Specifically, the claimed embodiments provide a leash that is held by a first of such loops on one end of the rope, while a collar of the pet is held by a ring and a clip at the opposite end of the rope. If the rope becomes tangled, the person lets go of the first loop to hold the second loop and pulls the rope such that the ring and the clip are allowed to slide along the rope towards the first loop. The rope thus becomes detangled. Therefore, the claimed embodiments allow for a leash that is less prone to tangling during use, and, if tangling should occur, facilitates detangling, without impairing the functionality of the leash.

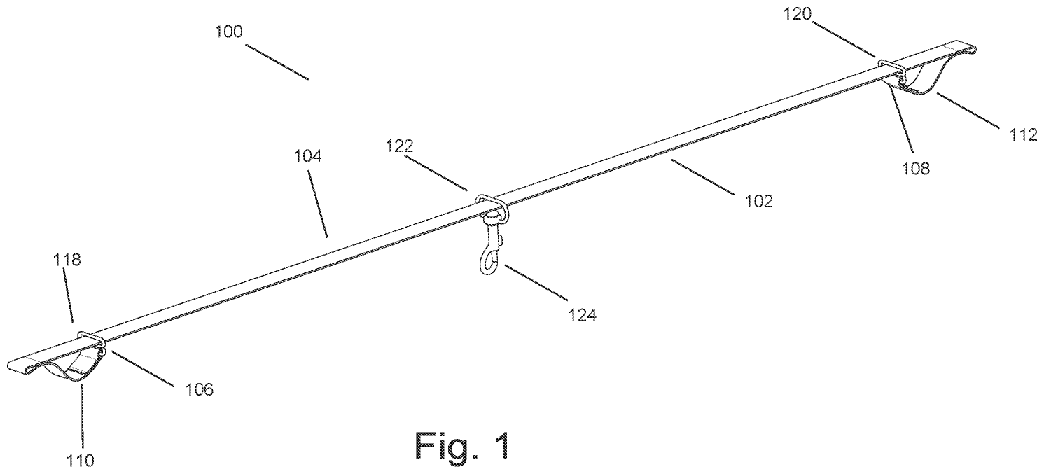

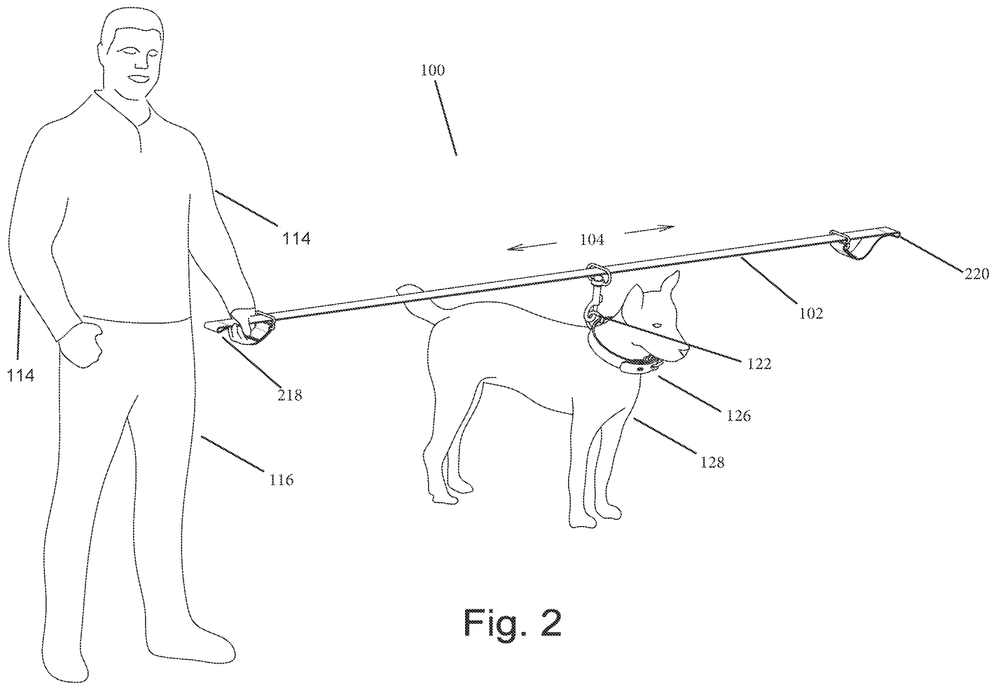

Now referring to the figures, FIG. 1 is a perspective view of a leash 100 for facilitating detangling, the pet leash shown in an extended orientation. The leash 100 includes a rope 102 having a length 104 disposed between a first end 106 and a second end 108 opposite the first end 106. A first loop 110 is attached at the first end 106 of the rope 102, and a second loop 112 is attached at the second end 108 of the rope 102. As indicated in FIG. 2, each loop 110, 112 is meant to be held by a hand 114 of a person 116. A first base 118 is located where the first loop 110 is attached to the first end 106 of the rope 102, and a second base 120 is located where the second loop 112 is attached to the second end 108 of the rope 102.

FIGS. 1 and 2 both depict a ring 122 that is also attached to the rope 102. As indicated by the arrows immediately surrounding the ring 122 in FIG. 2, the ring 122 is allowed to slide along the length 104 of the rope 102 between the first base 118 and the second base 120. Such sliding of the ring 122 prevents and/or reduces tangling of the rope 102 during use. A clip 124 is attached to the ring 122, and (as indicated in FIG. 2) allows for attachment to and detachment from the collar 126 of the pet 128. In one embodiment, the rope 102 is configured or constructed to allow for a glossy or slideable exterior finish, so as to reduce or eliminate the coefficient of friction of the ring 122 sliding against the rope. In one embodiment, the rope 102 is composed of a tightly woven nylon canvas with a thread count of at least 100 single-ply and a denier of at least 450. In said embodiment, the ring 122 is also configured or constructed to allow for a glossy or slideable exterior finish (such as a chrome finish), so as to reduce or eliminate the coefficient of friction of the ring sliding against the rope 102.

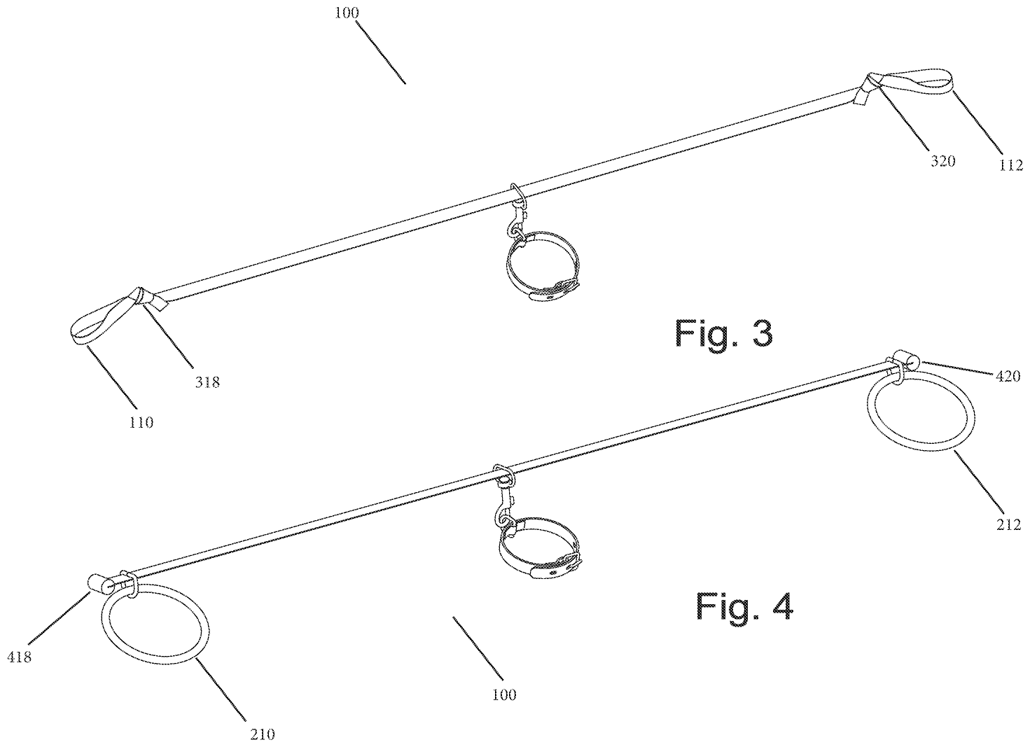

In an embodiment, detailed in FIGS. 1 and 2, the first loop 110 and the second loop 112 are each an extension of the length 104 of the rope 102. That is, the first loop 110 and the second loop 112 are both contiguous with, and made from a same material as, the rope 102. In one instance of such an embodiment, indicated in FIG. 2, the first base 118 and the second base 120 are each a buckle 218, 220. In another instance, detailed in FIG. 3, the first base 118 and the second base 120 are each a knot 318, 320 formed from a segment of the length 104 of the rope 102.

In another embodiment, illustrated in FIG. 4, the first loop 110 and the second loop 112 are each a ring 210, 212 coupled respectively to the first end 106 and the second end 108 of the rope 102. In such an embodiment, the first base 118 and the second base 120 are each a stopper 418, 420 coupled respectively around the first end 106 and the second end 108 of the rope 102. In a further embodiment, the first loop 110 and the second loop 112 are of same shape and equal size.

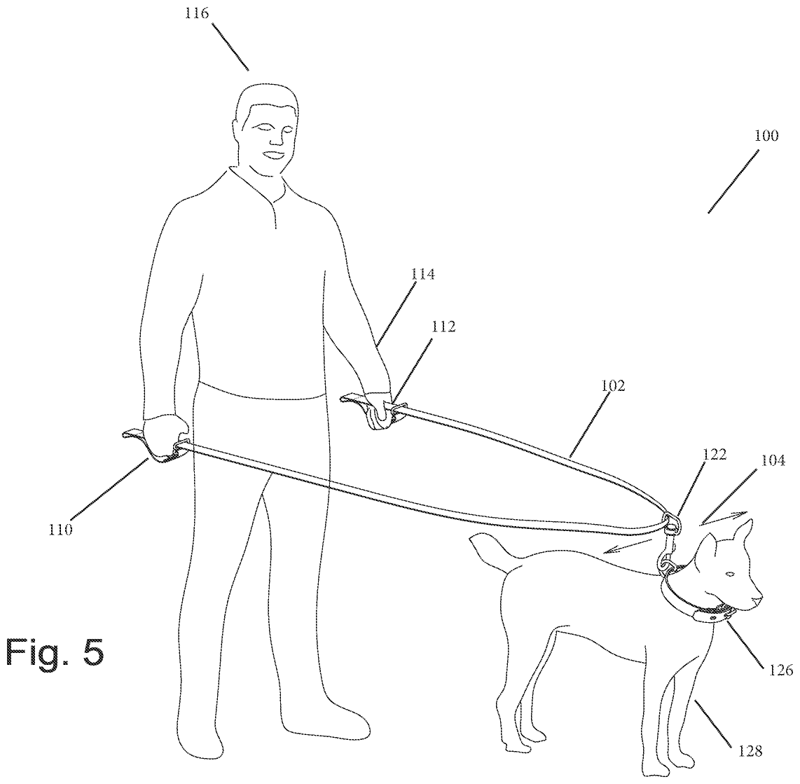

In yet another embodiment, indicated in FIG. 5, the first loop 110 and the second loop 112 may be held simultaneously by the person 116, either by one or two hands 114. In such an embodiment, the ring 122 is located along, and allowed to slide along, the length 104 of the rope 102 during use. The arrows immediately surrounding the ring 122 in FIG. 5 indicate such sliding.

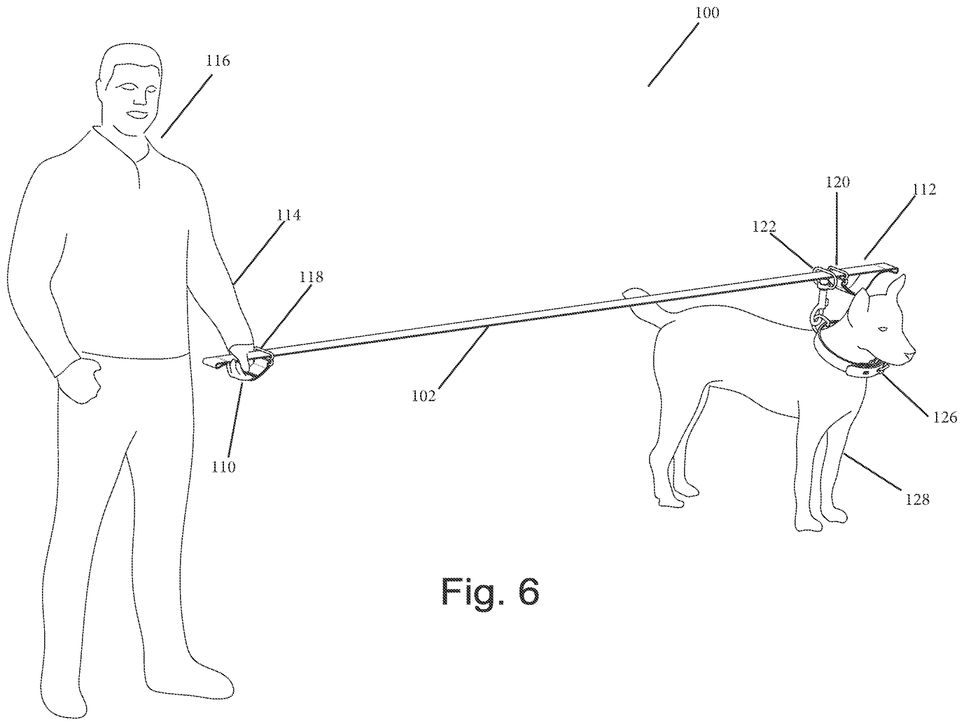

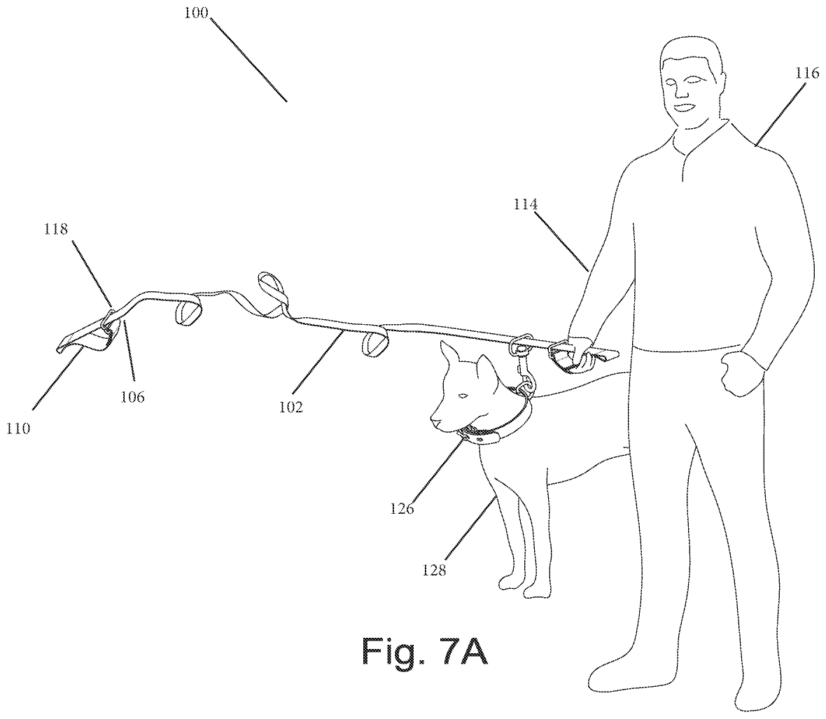

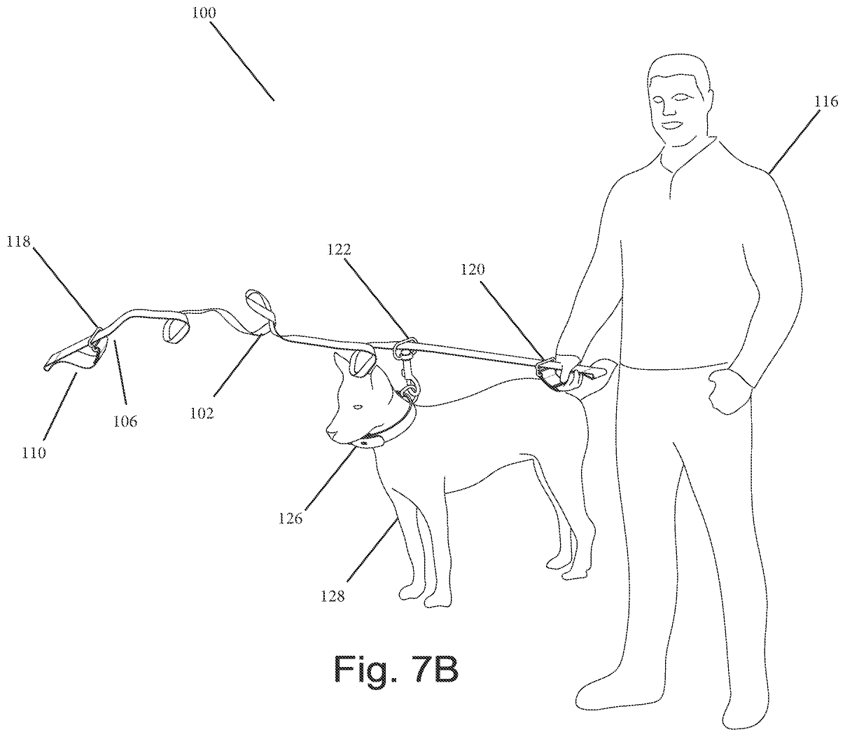

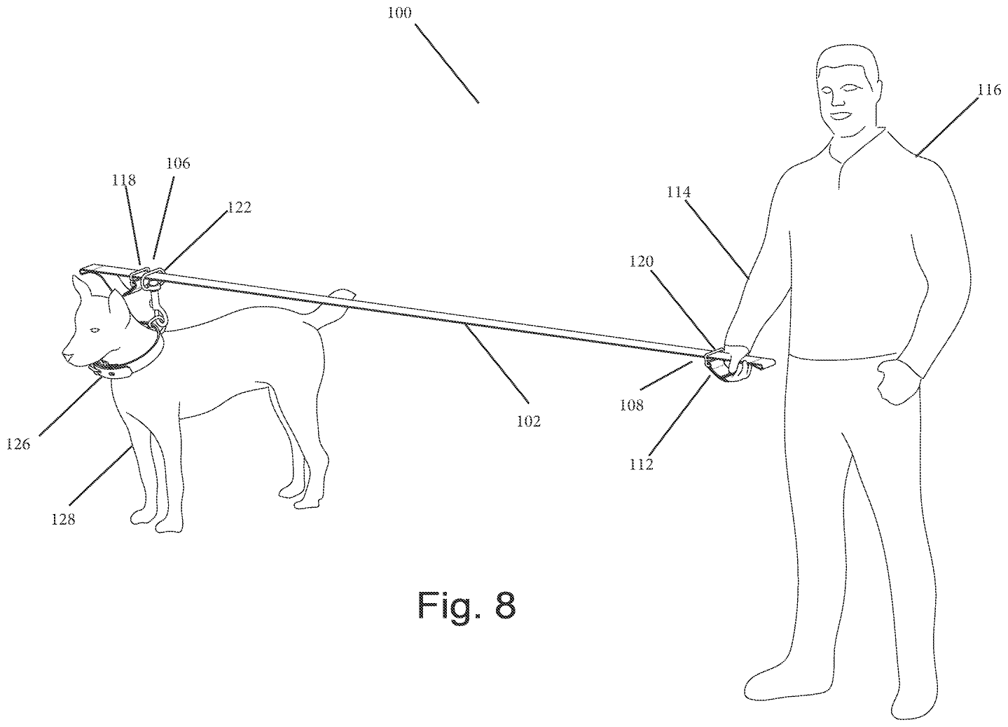

Use of the leash 100 is depicted in FIGS. 6-10. During use of the leash 100, a person 116 holds the leash 100 via the first loop 110, and the ring 122 is located at the second base 120 (FIG. 6). The pet 128 is thus held by the leash 100 at the second base 120, and the second loop 112 is allowed to hang freely. When the rope 102 becomes tangled (FIG. 7A), the person 116 unhandled (or let go of) the first loop 110 to hold the second loop 112. The rope 102 is allowed to be pulled via the second loop 112. Such pulling allows or enables the ring 122 to slide along the length 104 of the rope 102 to the first base 118, thereby detangling the rope 102 (FIG. 7B). Now, the pet 128 is held by the leash 100 at the first base 118, and the first loop 110 is allowed to hang freely (FIG. 8).

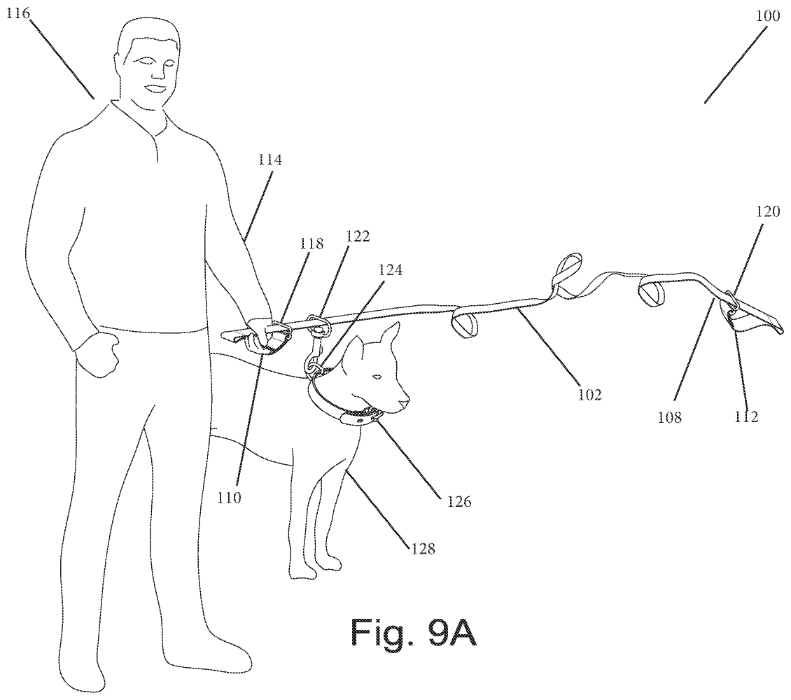

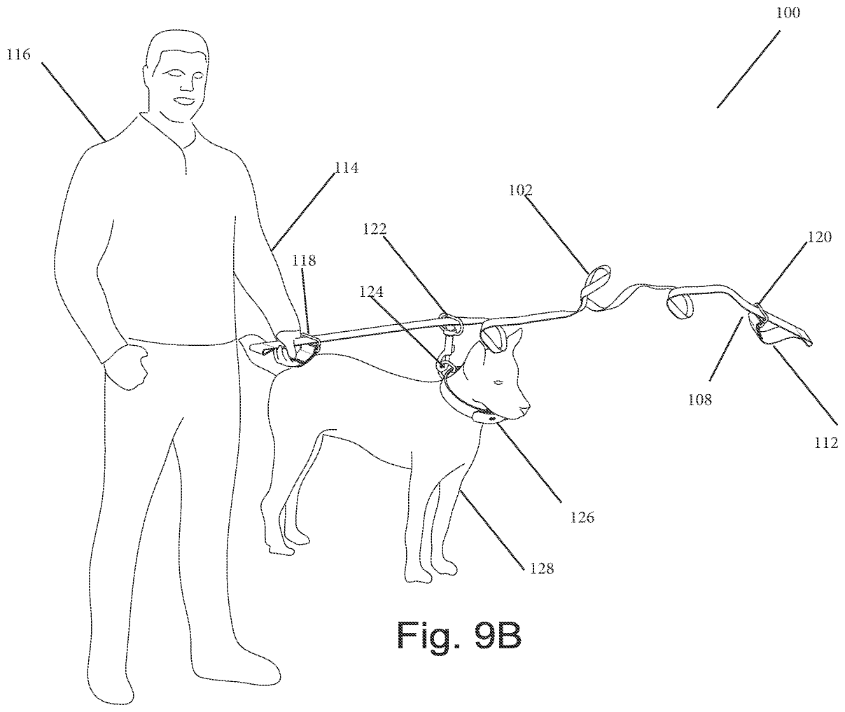

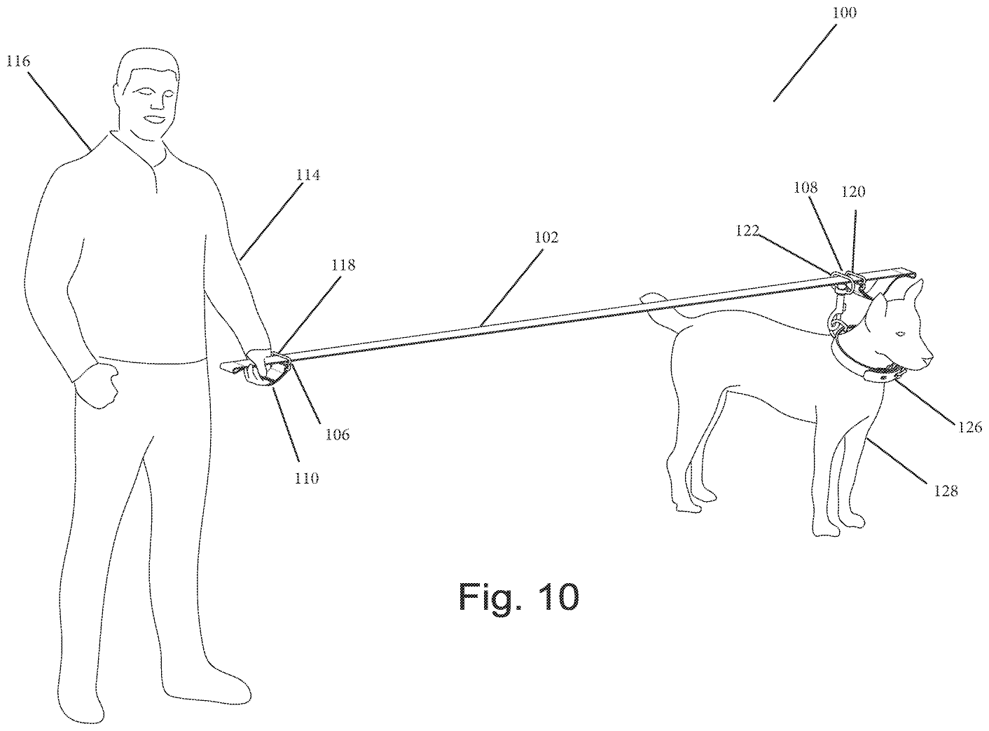

When the rope 102 becomes tangled again (FIG. 9A), the person 116 unhandled (or let go of) the second loop 112 to hold the first loop 110. The rope 102 is allowed to be pulled via the first loop 110. Such pulling allows or enables the ring 122 to slide along the length 104 of the rope 102 to the second base 120, thereby detangling the rope 102 once again (FIG. 9B). The pet 128 is once again held by the leash 100 at the second base 120, and the second loop 112 is allowed to hang freely (FIG. 10).

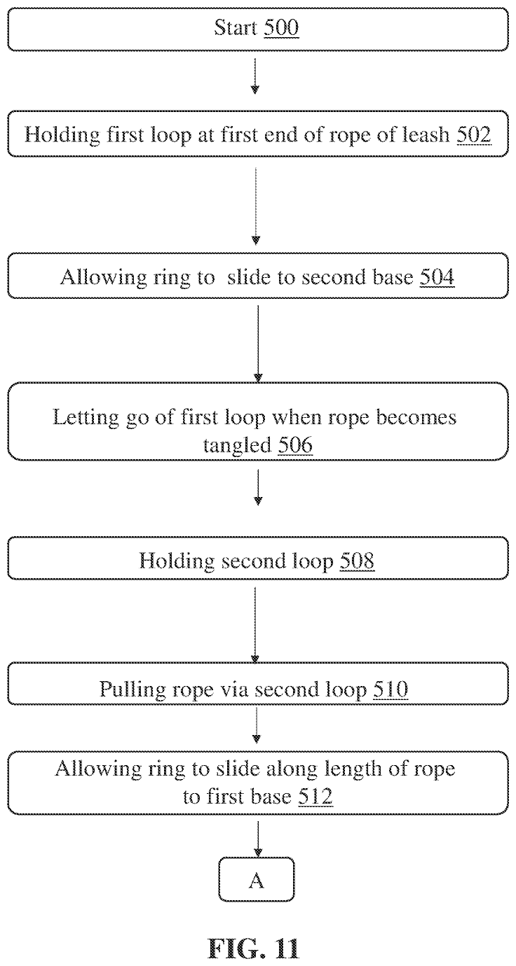

A method of using and detangling such a leash 100 is also presented and depicted in FIG. 11. The method starts in step 500, and in step 502, a person is holding a first loop 110 at a first end 106 of a rope 102 of the leash 100, opposite a second loop 112 at a second end 108 of the rope 102. A first base 118 is located at the first end 106, and a second base 120 is located at the second end 108. A ring 122 is attached to and allowed to slide along a length 104 of the rope 102 between the first base 118 and the second base 120. A clip 124 is attached to the ring 122 for attachment to and detachment from a collar 126 of a pet 128.

In second step 504 of the method, the user allows 504 the ring 122 to slide to the second base 120. In third step 506, the user lets go of the first loop 110 when the rope 102 becomes tangled. In fourth step 508 the user holds the second loop 112. In fifth step 510 the user pulls the rope 102 via the second loop 112. In sixth step 512 the user allows the ring 122 to slide along the length 104 of the rope 102 to the first base 118, thereby detangling the rope 102.

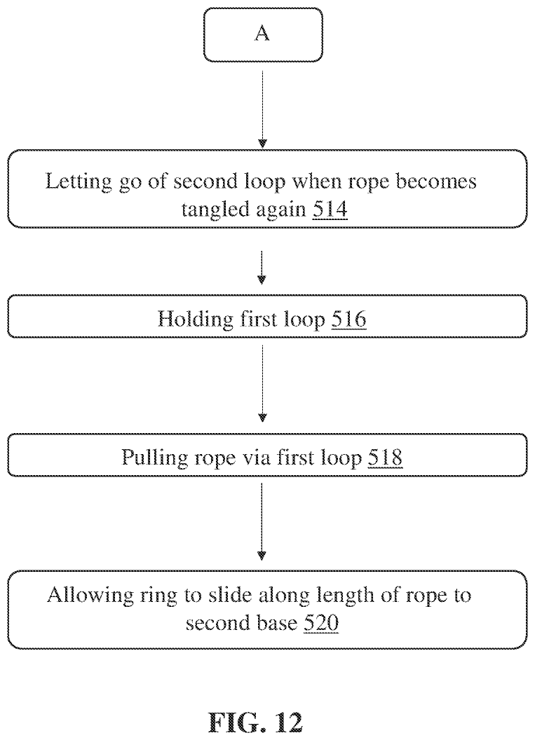

The method may continue in FIG. 12 if further tangling occurs. A subsequent step 514 includes letting go of the second loop 112 when the rope 102 becomes tangled again. Next step 516 includes holding the first loop 110, then pulling the rope 102 via the first loop 110 in step 518. The last step 520 includes allowing the ring 122 to slide along the length 104 of the rope 102 to the second base 120, thereby detangling the rope 102.

An additional method of using the leash 100 is also presented herein. In this method, a clip similar to clip 124 or similar to a carabiner (a shackle having a metal loop with a spring-loaded gate used to quickly and reversibly connect components) is attached to a loop, such as first loop 110. In this method, the user would like to secure his pet to a stationary object, such as a pole or a bike-rack. In this method, the user extends the first loop around the stationary object, such as a pole or a bike-rack, and attaches the clip to the second loop, such that the clip is now coupling the first loop to the second loop. As a result, the leash 100 is now secured to the stationary object, such as a pole or a bike-rack, such that the user can let go of the leash completely ad the pet cannot run away.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A pet leash for facilitating detangling, comprising:
a rope having a length disposed between a first end and a second end opposite the first end;
a first loop attached at the first end of the rope and a second loop attached at the second end of the rope, each loop for holding by a hand of a person;
a first base located where the first loop is attached to the first end of the rope and a second base located where the second loop is attached to the second end of the rope;
a ring attached to the rope, wherein the ring slides along the length of the rope between the first base and the second base, so as to prevent tangling of the rope during use; and
a clip attached to the ring, the clip configured for attachment to and detachment from a collar of a pet.

2. The leash of claim 1, wherein the first loop and the second loop are each an extension of the length of the rope.

3. The leash of claim 2, wherein the first base and the second base are each a buckle.

4. The leash of claim 1, wherein the first base and the second base are each a knot formed from a segment of the length of the rope.

5. The leash of claim 1, wherein the first loop and the second loop are each a ring coupled respectively to the first end and the second end of the rope.

6. The leash of claim 5, wherein the first base and the second base are each a stopper coupled respectively around the first end and the second end of the rope.

7. The leash of claim 1, wherein the first loop and the second loop are of same shape and equal size.

8. A pet leash for facilitating detangling, comprising:
a rope having a length disposed between a first end and a second end opposite the first end;
a first loop attached at the first end of the rope and a second loop attached at the second end of the rope, each loop for holding by a hand of a person, wherein the first loop and the second loop are each an extension of the length of the rope;
a first base located where the first loop is attached to the first end of the rope and a second base located where the second loop is attached to the second end of the rope, wherein the first base and the second base are each a buckle;
a ring attached to the rope, wherein the ring slides along the length of the rope between the first base and the second base, so as to prevent tangling of the rope during use; and
a clip attached to the ring, the clip configured for attachment to and detachment from a collar of a pet.

9. The leash of claim 8, wherein the first base and the second base are each a knot formed from a segment of the length of the rope.

10. The leash of claim 8, wherein the first loop and the second loop are each a ring coupled respectively to the first end and the second end of the rope.

11. The leash of claim 8, wherein the first base and the second base are each a stopper coupled respectively around the first end and the second end of the rope.

12. The leash of claim 8, wherein the first loop and the second loop are of same shape and equal size.

13. The leash of claim 8, further comprising a second clip coupled to the first loop, such that the second clip may be coupled to the second loop after the rope has been extended around a stationary object, such that the leash is secured to the stationary object.
